(19) United States
(12) Patent Application Publication
(10) Pub. No.: US 2018/0005457 A1
(43) Pub. Date: Jan. 4, 2018

(54) VISUAL POSITIONING DEVICE AND THREE-DIMENSIONAL SURVEYING AND MAPPING SYSTEM AND METHOD BASED ON SAME

(71) Applicant: BEIJING ANTVR TECHNOLOGY CO., LTD., Beijing (CN)

(72) Inventor: Zheng QIN, Beijing (CN)

(21) Appl. No.: 15/707,132

(22) Filed: Sep. 18, 2017

Related U.S. Application Data
(63) Continuation of application No. PCT/CN2016/077466, filed on Mar. 28, 2016.

(30) Foreign Application Priority Data
May 19, 2015 (CN) 201510257711.1

(51) Int. Cl. G06T 19/20; G06T 17/05; H04N 5/33

(52) U.S. Cl. CPC G06T 19/20; H04N 5/33; G06T 17/05; G06T 2219/2004

(57) ABSTRACT

Disclosed are a visual positioning device (101) and a three-dimensional surveying and mapping system (100) including at least one visual positioning device (101). The visual positioning device (101) includes an infrared light source (101b), an infrared camera (101a), a signal transceiver module (101d) and a visible light camera (101c). The three-dimensional surveying and mapping system (100) further includes a plurality of position identification points (102), a plurality of active signal points (103) and an image processing server (104). The image processing server (104) is configured to cache infrared images and real scene images shot by the infrared camera (101a) and the visible light camera (101c) and positioning information thereabout and store a three-dimensional model obtained through reconstruction. The present invention has the advantages of simple structure, no need for a power supply, convenience in use and high precision, etc.

### CROSS-REFERENCE TO RELATED APPLICATION

This application is a continuation application of International Patent Application No. PCT/CN2016/077466, filed on Mar. 28, 2016, which itself claims priority to Chinese Patent Application No. 201510257711.1, filed on May 19, 2015 in the State Intellectual Property Office of P.R. China, which are hereby incorporated herein in their entireties by reference.

### FIELD OF THE INVENTION

The present invention relates to a visual positioning device, and more particularly to a three-dimensional surveying and mapping system and method based on same.

### BACKGROUND OF THE INVENTION

Generally, in the field of computer vision, especially the field of virtual reality, an image of an identification point in an environment is by processed and analyzed, and coordinate information and attitude information of a moving target are determined.

Currently, commonly used identification points are active signal points. As a large number of active signal points are needed, high costs are required. Positioning in a large space requires a large number of such active identification points. At present, during surveying and mapping, a three-dimensional surveying and mapping vehicle is usually used to perform image shooting and image reconstruction according to a predetermined route, leading to such disadvantages as that the type of corresponding position point for obtaining the image is limited and the image updating speed is low.

In view of the above-mentioned deficiencies in the prior art, it is necessary to develop a three-dimensional surveying and mapping system and method that feature a simple structure, convenience in deployment, multi-point shooting, and high updating speed.

### SUMMARY OF THE INVENTION

An objective of the present invention is to provide a visual positioning device, including an infrared camera, a visible light camera and a signal transceiver module, wherein the infrared camera is configured to continuously obtain infrared images including a plurality of position identification points; the visible light camera is configured to shoot a real scene image of a current environment, and has a same shooting range as the infrared camera and performs shooting synchronously with the infrared camera; and the signal transceiver module is configured to receive a geographic location signal sent from the outside, send the geographic location signal and the shot infrared images and real scene image to a remote server, receive processed three-dimensional model data sent from the remote server, and reconstruct a three-dimensional model according to the data.

Preferably, the position identification points are a plurality of infrared light source points.

Preferably, the visual positioning device further includes an infrared light source configured to emit infrared light to the environment, wherein the position identification points are identification points made of a highly infrared-reflective material.

Preferably, the position identification points are made of a metal powder.

Preferably, the position identification point is an adhesive or meltable sheet structure.

Preferably, the infrared camera and the visible light camera are wide-angle cameras.

Also disclosed is a three-dimensional surveying and mapping system including at least one visual positioning device described above, the system further including a plurality of position identification points, a plurality of active signal points, and an image processing server, wherein the position identification points are arranged at equal intervals on a plane that needs to be positioned; the active signal point is configured to actively send a coordinate position signal thereof to the visual positioning device;

the image processing server is configured to cache the real scene image, the infrared images and corresponding absolute position information and store a three-dimensional model obtained through reconstruction; and the image processing server continuously obtains a positional relationship between at least three position identification points in the infrared image that are not on a same straight line, compares a positional relationship between neighboring position identification points to obtain continuous changes in a relative position and a relative attitude of the visual positioning device to implement precise positioning of the visual positioning device, further selects a corresponding real scene image according to precise positioning information, reconstructs a three-dimensional model, and sends the three-dimensional model to the at least one visual positioning device by broadcasting.

Preferably, the positional relationship between the position identification points includes a distance between the position identification points, an angle between lines connecting the position identification points, and an area surrounded by the lines.

Preferably, the visual positioning device is capable of simultaneously receiving position signals sent from at least three active identification points.

Also disclosed is a visual positioning-based three-dimensional surveying and mapping method, including the following steps:

a) shooting, by a visual positioning device, a first infrared image and a first real scene image, determining absolute position information of the visual positioning device according to information sent from an active signal point, transmitting the first infrared image, the first real scene image and the absolute position information of the visual positioning device to an image storage unit in an image processing server for storage, and recording a first shooting time;

b) determining, by an image processing unit, whether a number of position identification points in the first infrared image is at least three and the position identification points are not on a same straight line; if yes, selecting one or more groups of at least three points that are not on a same straight line and constructing a first family polygon, and performing step c); otherwise, returning to the step a);

c) shooting, by the visual positioning device, a second infrared image and a second real scene image, storing the second infrared image and the second real scene image, and recording a second shooting time ;

d) determining whether a number of infrared identification points in the second infrared image is at least three and the infrared identification points are not on a same straight line; if yes, selecting one or more groups of at least three points that are not on a same straight line and constructing a second family polygon, and performing step e); otherwise, returning to the step c);

e) calculating a relative displacement and/or shape change between the first family polygon and the second family polygon, obtaining relative displacement and attitude information of the moving target at the second shooting time relative to the first shooting time, and implementing precise positioning based on the absolute position information; and

f) obtaining, from the image storage unit according to precise positioning information, a corresponding real scene image and neighboring real scene images overlapping the real scene image, reconstructing a three-dimensional model, and sending the three-dimensional model to the at least one visual positioning device by broadcasting.

Based on the above, the visual positioning device and the three-dimensional surveying and mapping system and method based on same of the present invention have the advantages of simple structure, no need for a power supply, convenience in use and high precision, etc. It should be understood that the above general description and the following detailed description are both provided for exemplary and explanatory purposes, and should not be construed as limiting the scope of protection of the present invention.

### BRIEF DESCRIPTION OF THE DRAWINGS

Further objectives, effects, and advantages of the present invention will become apparent from the following description of the embodiments of the present invention with reference to the accompanying drawings, wherein:

FIG. 1 schematically illustrates a schematic application diagram of a visual positioning system according to the present invention;

FIG. 2 schematically illustrates a system block diagram of a visual positioning system according to the present invention; and

FIG. 3A and FIG. 3B schematically illustrate diagrams of image processing and analysis in a visual positioning method according to the present invention, respectively.

### DETAILED DESCRIPTION OF THE INVENTION

The objectives and functions of the present invention and the method for achieving these objectives and functions will be described in detail with reference to exemplary embodiments. However, the present invention is not limited to the exemplary embodiments disclosed below, but may be implemented in different forms. The essence of this specification is merely for the purpose of helping those skilled in the art to have a comprehensive understanding of the details of the present invention.

The embodiments of the present invention will be described below with reference to the accompanying drawings. In the accompanying drawings, same reference numerals represent same or similar parts or same or similar steps.

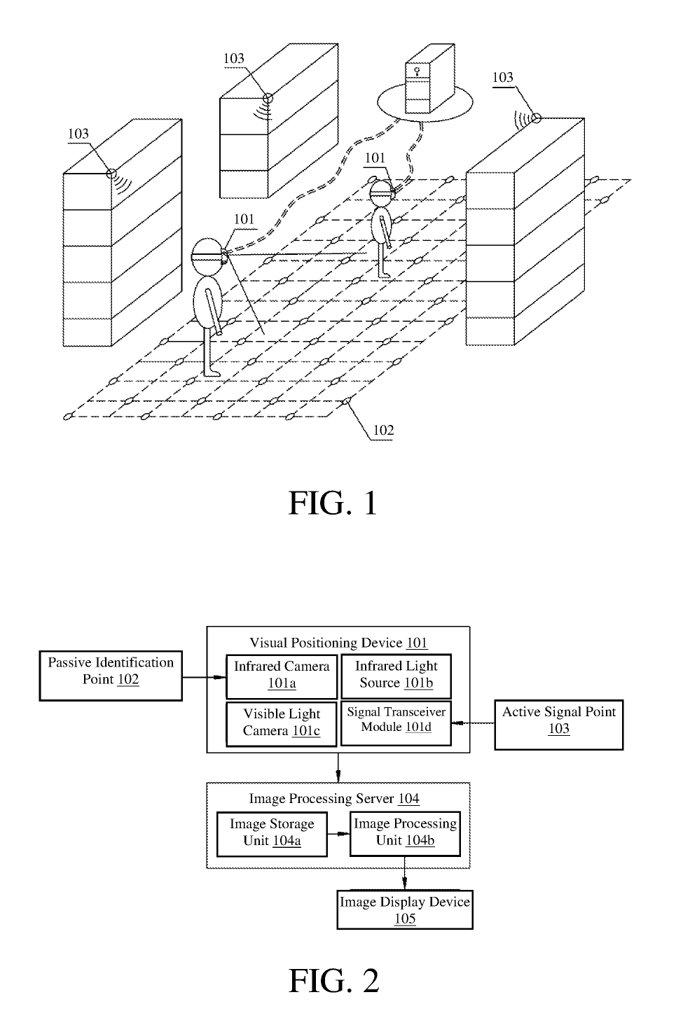

FIG. 1 and FIG. 2 respectively illustrate a schematic application diagram and a system block diagram of a visual positioning-based three-dimensional surveying and mapping system 100 according to the present invention. The three-dimensional surveying and mapping system 100 of the present invention includes a visual positioning device 101, position identification points 102, active signal points 103, and an image processing server 104.

The visual positioning device 101 mainly includes an infrared camera 101a, a visible light camera 101c and a signal transceiver module 101d. The three-dimensional surveying and mapping system 100 of the present invention includes at least one visual positioning device 101.

The infrared camera 101a is preferably a wide-angle camera, and is configured to continuously shoot a reflective photograph of an external position identification point 102, and transmit the shot infrared image to the image processing server. The number of the infrared cameras 101a is one or two.

The infrared camera 101a is configured to shoot an image of a current scene, and perform image shooting synchronously with the infrared camera 101a. The visible light camera 101c and the infrared camera 101a are arranged side by side and should have an identical shooting range. A real scene image shot by the visible light camera 101c is also transmitted to the image processing server.

The signal transceiver module 101d is configured to receive absolute position information thereof sent from an external active signal point 103, and therefore can record absolute position information corresponding to the infrared camera 101a or the visible light camera 101c when an image is shot. The signal transceiver module 101d may further send data information to the outside, for example, send images shot by the infrared camera 101a and the infrared camera 101a to a server end continuously or at intervals. In addition, the signal transceiver module 101d may further receive processed three-dimensional model data sent from a remote server and reconstruct a three-dimensional model according to the data.

Preferably, the present invention the visual positioning device 101 further includes an infrared light source 101b. The infrared light source 101b is configured to emit infrared light. The infrared light is irradiated to and reflected by the position identification points 102. The irradiation range of the infrared light should cover the shooting area of the infrared camera 101a.

The position identification points 102 are made of a highly infrared-reflective material, for example, a metal powder (having a reflective index of up to 80-90%). The identification point is generally fabricated into an adhesive or meltable sheet structure, and is adhered or melted at a placed to be positioned, to reflect the infrared light emitted from the infrared light source 101b, so as to be captured by the infrared camera 101a during shooting and displayed as a light spot in the image. According to a positional relationship between light spots in the image, continuous changes in a relative position and attitude of the infrared camera 101a relative to the identification point 102 are determined. In addition, the position identification point 102 may be an active-emission infrared light source point, for example, an infrared LED light.

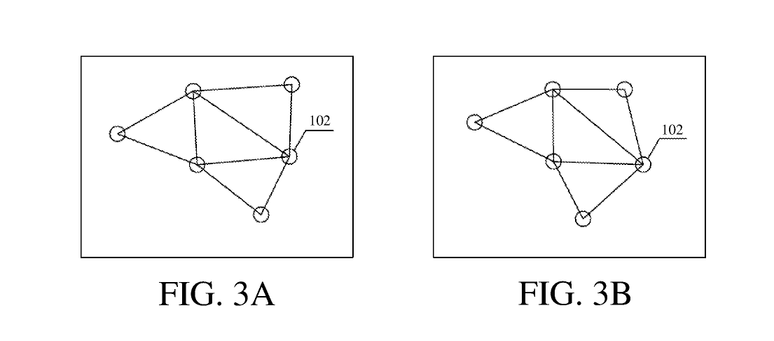

The plurality of position identification points 102 is arranged in a positioning space to form a mesh with equal intervals, for example, a square mesh or regular-triangle mesh with equal intervals (as shown in FIG. 3A and FIG. 3B). The identification point 102 is a passive position identification point, that is, the identification point 102 itself does not have specific coordinate information. When used for indoor positioning, the identification point 102 may be adhered on a floor or wall surface indoor, or integrated with the floor or wall surface, for example, adhered or integrated at intersections of four sides of each piece of floorboard or directly embedded in the floor surface; when used for outdoor positioning, the identification point 102 may be laid on a road outside or integrated with a zebra crossing on the road, or laid at other places that need to be positioned.

The active signal point 103 is configured to provide absolute position information to the visual positioning device 101. Because the position identification point 102 of the present invention is mainly used for obtaining a change in the relative position, the present invention should further include a plurality of active signal points 103. Each active signal point 103 has absolute coordinate information and actively sends an absolute position signal to the signal transceiver module 101d, so as to implement absolute positioning of the visual positioning device 101. The active signal point 103 is used for performing absolute positioning in a large range, and the position identification point 102 is used for performing precise relative positioning in a small local range and obtaining attitude information. Quick precise positioning can be achieved by combining absolute positioning in a large range with relative positioning in a small range.

It is not necessary to provide a large number of active signal points 103 as long as the visual positioning device 101 can simultaneously receive signals sent from three active signal points 103. The active signal point 103 is generally disposed at the top edge of a building or on an advertising board, and is configured to continuously emit location signals for calibrating the absolute position information of the visual positioning device 101, to prevent a large error. A user may wear a head-mounted display device integrated with the visual positioning device 101 of the present invention to enter a virtual environment, and by using the active signal points 103 and the plurality of identification points 102 to perform precise positioning, virtual reality can be achieved.

The image processing server 104 includes an image storage unit 104a and an image processing unit 104b.

The image storage unit 104a is configured to cache the infrared images and the real scene image shot by the infrared camera 101a and the visible light camera 101c and positioning information thereabout and store a three-dimensional model obtained through reconstruction. A user wearing a wearable display device having the three-dimensional surveying and mapping system of the present invention may shoot a large number of real scene images. The larger the number of users is, the more real scene images are obtained. A large number of real scene images provide images required for reconstructing the three-dimensional model.

The image processing unit 104b determines a change in the relative position of the visual positioning device 101 according to a positional relationship between the position identification points 102 in the infrared image and implements precise positioning of the visual positioning device 101 according to the absolute position information of the active signal points 103, and stores precise positioning information to a record corresponding to the real scene image that is shot synchronously with the infrared image; and selects a related real scene image according to the precise positioning information of the visual positioning device 101, reconstructs a three-dimensional model, and sends, by broadcasting, the three-dimensional model to a terminal display device that needs to display the three-dimensional model. The related real scene image may be deleted directly or after being kept for a period of time.

The image processing unit 104b analyzes reflective positions of the position identification points 102 in the infrared image, to determine relative position and attitude information of the infrared camera 101a relative to the position identification points 102 in the image. If the plurality of position identification points 102 is arranged in a square or right-triangle mesh, the infrared image should include at least three position identification points 102 that are not on a same straight line, and the image processing unit 104b further obtains the positional relationship between the position identification points 102, to implement relative positioning; if there are redundant position identification points 102, the redundant position identification points 102 may be used for checking the accuracy of positioning, thereby improving the precision of visual positioning.

Lines connecting the plurality of identification points 102 in the infrared image form a multi-family triangle or quadrilateral, as shown in FIG. 3A and FIG. 3B. The image processing unit 104b can determine the relative position and attitude information of the infrared camera 101a by analyzing a positional relationship (for example, angle, side length and area) of one of family triangles or quadrilaterals. For example, if the quadrilateral is a square, it indicates that the infrared camera 101a exactly faces the plane in which the position identification points 102 are located; if the quadrilateral is not a square, it indicates that a shooting angle exists between the infrared camera 101a and the plane in which the position identification points 102 are located, and the image processing unit 104b further processes the image to obtain the side length, angle or area of the quadrilateral, so as to calculate continuous positional relationship and attitude information of the infrared camera 101a relative to the position identification points 102.

The three-dimensional reconstruction processing performed by the image processing unit 104b on the real scene image includes the following steps:

1) obtaining a precise position of the visual positioning device 101, where the precise position includes absolute position and attitude information of the visual positioning device 101;

2) obtaining, according to the precise positioning information in 1), a corresponding real scene image and neighboring real scene images overlapping the real scene image;

3) performing three-dimensional reconstruction by using multiple overlapping real scene images, to obtain a three-dimensional the real scene image; and

4) transmitting the reconstructed three-dimensional real scene image to the terminal display device 105.

According to the above content, a visual positioning-based three-dimensional surveying and mapping method can be obtained. Specifically, current absolute position and attitude information of a moving target provided with the visual positioning device 101 of the present invention is obtained, and a three-dimensional model of the current position is further reconstructed and displayed in a corresponding terminal display device 105. The method includes the following steps:

a) shooting, by a visual positioning device 101, a first infrared image and a first real scene image, determining absolute position information of the visual positioning device 101 according to information sent from an active signal point 103, transmitting the first infrared image, the first real scene image and the absolute position information of the visual positioning device 101 to an image storage unit 104a in an image processing server 104 for storage, and recording a first shooting time;

b) determining, by an image processing unit 104b, whether a number of position identification points 102 in the first infrared image is at least three and the position identification points are not on a same straight line; if yes, selecting one or more groups of at least three points that are not on a same straight line and constructing a first family polygon, and performing step c); otherwise, returning to the step a);

c) shooting, by the visual positioning device 101, a second infrared image and a second real scene image, storing the second infrared image and the second real scene image, and recording a second shooting time;

d) determining whether a number of infrared identification points 102 in the second infrared image is at least three and the infrared identification points are not on a same straight line; if yes, selecting one or more groups of at least three points that are not on a same straight line and constructing a second family polygon, and performing step e); otherwise, returning to the step c);

e) calculating a relative displacement and/or shape change between the first family polygon and the second family polygon, obtaining relative displacement and attitude information of the moving target at the second shooting time relative to the first shooting time, and implementing precise positioning based on the absolute position information; and

f) obtaining, from the image storage unit 104a according to precise positioning information, a corresponding real scene image and neighboring real scene images overlapping the real scene image, reconstructing a three-dimensional model, and sending the three-dimensional model to the at least one visual positioning device 101 or other terminal display device 105 by broadcasting.

The visual positioning-based three-dimensional surveying and mapping system and method of the present invention can be applied to a wide range of fields such as intelligent robots, head-mounted display devices, blind guiding and navigation. When used in a head-mounted display device, the visual positioning device 101 of the present invention is generally integrated with the head-mounted display device. After a user wears the head-mounted display device integrated with the visual positioning device 101 of the present invention, a precise position of the user can be determined. A reconstructed three-dimensional model is displayed on the screen of the head-mounted display device, so that the user can enter a virtual reality world by means of the head-mounted display device.

Based on the above, the visual positioning-based three-dimensional surveying and mapping system and method of the present invention can implement precise positioning and three-dimensional model reconstruction. The combination of the active signal points 103 and the position identification points 102 greatly reduces the number of active signal points 103 required. In addition, the position identification points 102 made of a highly infrared-reflective material have the advantages of simple structure, no need for a power supply, convenience in use, low costs, no delay and high positioning precision, etc.

The accompanying drawings are merely schematic and are not drawn to scale. It should be understood that although the present invention has been described with reference to preferred embodiments, the scope of protection of the present invention is not limited to the embodiments described herein.

Based on the description and practice of the present invention as disclosed herein, other embodiments of the present invention are readily conceived of and understood to those skilled in the art. The description and embodiments are provided for exemplary purpose only. The real scope and spirit of the present invention are defined by the claims.

What is claimed is:

1. A visual positioning device, comprising an infrared camera, a visible light camera and a signal transceiver module, wherein the infrared camera is configured to continuously obtain infrared images comprising a plurality of position identification points; the visible light camera is configured to shoot a real scene image of a current environment, and has a same shooting range as the infrared camera and performs shooting synchronously with the infrared camera; and the signal transceiver module is configured to receive a geographic location signal sent from the outside, send the geographic location signal and the shot infrared images and real scene image to a remote server, receive processed three-dimensional model data sent from the remote server, and reconstruct a three-dimensional model according to the data.

2. The visual positioning device according to claim 1, wherein the position identification points are a plurality of infrared light source points.

3. The visual positioning device according to claim 1, further comprising an infrared light source configured to emit infrared light to the environment, wherein the position identification points are identification points made of a highly infrared-reflective material.

4. The visual positioning device according to claim 3, wherein the position identification points are made of a metal powder.

5. The visual positioning device according to claim 3, wherein the position identification point is an adhesive or meltable sheet structure.

6. The visual positioning device according to claim 1, wherein the infrared camera and the visible light camera are wide-angle cameras.

7. A three-dimensional surveying and mapping system comprising at least one visual positioning device according to claim 1, further comprising a plurality of position identification points, a plurality of active signal points, and an image processing server, wherein the position identification points are arranged at equal intervals on a plane that needs to be positioned; the active signal point is configured to actively send a coordinate position signal thereof to the visual positioning device; the image processing server is configured to cache the real scene image, the infrared images and corresponding absolute position information and store a three-dimensional model obtained through reconstruction; and the image processing server continuously obtains a positional relationship between at least three position identification points in the infrared image that are not on a same straight line, compares a positional relationship between neighboring position identification points to obtain continuous changes in a relative position and a relative attitude of the visual positioning device to implement precise positioning of the visual positioning device, further selects a corresponding real scene image according to precise positioning information, reconstructs a three-dimensional model, and sends the three-dimensional model to the at least one visual positioning device by broadcasting.

8. The three-dimensional surveying and mapping system according to claim 7, wherein the positional relationship between the position identification points comprises a distance between the position identification points, an angle between lines connecting the position identification points, and an area surrounded by the lines.

9. The three-dimensional surveying and mapping system according to claim 7, wherein the visual positioning device is capable of simultaneously receiving position signals sent from at least three active identification points.

10. A visual positioning-based three-dimensional surveying and mapping method, comprising the following steps:
a) shooting, by a visual positioning device, a first infrared image and a first real scene image, determining absolute position information of the visual positioning device according to information sent from an active signal point, transmitting the first infrared image, the first real scene image and the absolute position information of the visual positioning device to an image storage unit in an image processing server for storage, and recording a first shooting time;
b) determining, by an image processing unit, whether a number of position identification points in the first infrared image is at least three and the position identification points are not on a same straight line; if yes, selecting one or more groups of at least three points that are not on a same straight line and constructing a first family polygon, and performing step c); otherwise, returning to the step a);
c) shooting, by the visual positioning device, a second infrared image and a second real scene image, storing the second infrared image and the second real scene image, and recording a second shooting time;
d) determining whether a number of infrared identification points in the second infrared image is at least three and the infrared identification points are not on a same straight line; if yes, selecting one or more groups of at least three points that are not on a same straight line and constructing a second family polygon, and performing step e); otherwise, returning to the step c);
e) calculating a relative displacement and/or shape change between the first family polygon and the second family polygon, obtaining relative displacement and attitude information of the moving target at the second shooting time relative to the first shooting time, and implementing precise positioning based on the absolute position information; and
f) obtaining, from the image storage unit according to precise positioning information, a corresponding real scene image and neighboring real scene images overlapping the real scene image, reconstructing a three-dimensional model, and sending the three-dimensional model to the at least one visual positioning device by broadcasting.
